(19) United States
(12) Patent Application Publication
(10) Pub. No.: US 2010/0013659 A1
(43) Pub. Date: Jan. 21, 2010

(54) COMPACT VISUAL INDICATIONS OF SCHEDULE SATURATION

(76) Inventors: Glenn H. Farrell, Peoria, IL (US); Gary J. Rhodes, Springfield, IL (US)

Correspondence Address: Russ Weinzimmer, 614 Nashua Street, Suite 53, Milford, NH, 03055, US

(21) Appl. No.: 12/176,396

(22) Filed: Jul. 20, 2008

(51) Int. Cl. G08B 5/00

(52) U.S. Cl. 340/815.65; 340/815.4

(57) ABSTRACT

A software tool, device, and method are disclosed for displaying schedule saturation. Schedule saturation indicators on an electronic display provide compact and easily comprehended visual overviews of the schedule saturations of days, weeks, months, etc, without attempting to display hour-by-hour schedule information. For example, a half-red, half-green rectangle can indicate that a day's schedule is half full. Optimal time periods can then be expanded for appointment scheduling. Visual indications of schedule saturation can vary in degree of filling, size, orientation, configuration, location, marking density, shading, color hue, and color intensity. A plurality of time interval and schedule saturation indicators can be displayed simultaneously, individual saturation indicators can be subdivided to indicate relative amounts of saturation due to different categories of events, and available portions of time periods can be specified such that saturation indicators indicate saturation of the available portions.

### FIELD OF THE INVENTION

The invention generally relates to tools for management of schedules and appointments, and more specifically to electronic tools for indicating and managing schedules.

### BACKGROUND OF THE INVENTION

Keeping track of appointment schedules is a very well known and nearly universal need. For both professional and social reasons, it is typically necessary for most individuals to keep track of activities and plans using some kind of schedule organizing tool so as to avoid schedule conflicts, and so as to ensure that planned appointments are kept.

Traditional schedule management tools include printed calendars and appointment books, the pages of which present the days of a month, the days of a week, the hours of a day, and so forth, so that appointments and activities can be noted using a pen or pencil. These tools are limited in their flexibility, in that changes are difficult to make, and there is no convenient means to move from overviews of large time periods to detailed displays of short time periods. For example, if schedule information is recorded in a page-per-month calendar, it can be difficult to record and see hour-by-hour appointments for a given day. And if schedule information is recorded in a page-per-day calendar or appointment book, it can be difficult to gain an overview of an entire week or month without flipping through a plurality of pages.

In recent years, electronic schedule tracking tools have come into common use. These include software tools that can be loaded and operated on general purpose computers or on compact, portable devices such as Personal Digital Assistants (PDA's), as well as dedicated electronic devices with similar software tools permanently installed thereon. Electronic schedule tracking tools are able to easily and quickly switch between different display formats, making it easy to view a month at a glance and then to examine schedules for certain days or weeks in more detail by using a pointing device or other computer control means to select and expand the desired time period.

However, the display areas and resolutions of electronic schedule tracking tools are limited, often being smaller than the pages of traditional calendars and appointment books. Therefore, it is typically necessary to make repeated changes of the display format and of the displayed time period so as to select a time for an appointment or obtain desired information regarding the schedule for a certain period of time.

If, for example, a user of such an electronic schedule management device wishes to schedule an appointment, it may be necessary for the user to sequentially view the schedule for each individual day that is a potential candidate for the appointment until a suitable day and time is found. This can require an excessive amount of time and effort, especially when there is considerable flexibility as to the choice of a day and time for the appointment. Although it may be possible to quickly find an arbitrary day and time that is available, it may nevertheless be preferable to find an optimal time for the appointment by scheduling it during a day or a week that is not already overly burdened with appointments. So as to find such an optimal day and time, it may be necessary to review the daily schedule of each day, one by one, during a lengthy timeframe, so as to finally determine the week or day with the least scheduling burden, and then select an appropriate appointment time during that week or day.

Efforts have been made to provide more compact indications of daily schedules, so as to allow a more rapid determine of daily schedule burdens. For example, timeline indications are provided by some electronic schedule tracking tools that display an overview of scheduled and free time periods during each day. However, these approaches are still limited in their compactness by the need to display a timeline for each day, each timeline being of sufficient dimensions to indicate the scheduling status of each hour during each displayed day.

### SUMMARY OF THE INVENTION

A software tool and method of use thereof are claimed for displaying schedule saturation indicators on an electronic display, each schedule saturation indicator providing a compact and easily comprehended overview of the schedule saturation of a day, week, month, or some other time period. For example, in a preferred embodiment, if half of the available time in a given day is scheduled, a bar will be displayed that is half green and half red, thereby readily conveying the information that the day is “half filled.”

By not attempting to display hour-by-hour schedule information, the schedule saturation indicators of the present invention are able to provide an overview of the schedule saturation of any desired time period in a highly compact and easily understood fashion. When more detailed information is desired, a user can then use a pointing device or other appropriate means to select a time period of interest and obtain full schedule information thereof.

A first general aspect of the invention is an article of manufacture for visually indicating a degree of schedule saturation of a time period. The item of manufacture is media containing software that is able to direct the actions of an electronic device so as to present schedule related items on an electronic display. The schedule related items include a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

In preferred embodiments, the schedule related items further include a time-interval-indicator representative of the time interval during which events can be scheduled, the time-interval-indicator being cooperative with the schedule saturation indicator. In some of these preferred embodiments, the time interval represented by the time-interval-indicator is an hour, a day, a week, a month, a quarter, or a year.

In various preferred embodiments, the schedule related items further include a user interface mechanism that enables a user to specify an available fraction of the time interval, the available fraction being a fraction of the time interval that is available for event scheduling, such that the schedule saturation indicator indicates the schedule saturation of the available fraction of the time interval.

In some preferred embodiments, the schedule saturation indicator is able to provide a visual indication of a fraction by displaying at least one of the following:

a numeric indication;

a fractionally filled graphical element;

a graphical element of variable size;

a graphical element of variable orientation;

a graphical element with a continuously variable configuration;

a marker positioned within a visually designated range of locations;

a color included in a graphical element, the color being selected from a range of colors;

markings of variable density within a graphical element;

shading of variable density within a graphical element; and

a color of variable intensity within a graphical element.

In various preferred embodiments, the schedule saturation indicator is able to provide a visual indication of a plurality of degrees of saturation, each of the plurality of degrees of saturation indicating a percent of the time interval that is scheduled with events of a specific type. And in certain preferred embodiments the schedule saturation indicator is a rectangle partially filled with a green region and partially filled with a red region.

A second general aspect of the invention is a device for visually indicating a degree of schedule saturation of a time period. The device is an electronic device that is able to display schedule related items on an electronic display. The schedule related items include a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

In preferred embodiments, the schedule related items further include a time-interval-indicator representative of the time interval during which events can be scheduled, the time-interval-indicator being cooperative with the schedule saturation indicator. In some of these preferred embodiments, the time interval represented by the time-interval-indicator is an hour, a day, a week, a month, a quarter, or a year.

In various preferred embodiments, the schedule related items further include a user interface mechanism that enables a user to specify an available fraction of the time interval, the available fraction being a fraction of the time interval that is available for event scheduling, such that the schedule saturation indicator indicates the schedule saturation of the available fraction of the time interval.

In some preferred embodiments, the schedule saturation indicator is able to provide a visual indication of a fraction by displaying at least one of the following:

a numeric indication;

a fractionally filled graphical element;

a graphical element of variable size;

a graphical element of variable orientation;

a graphical element with a continuously variable configuration;

a marker positioned within a visually designated range of locations;

a color included in a graphical element, the color being selected from a range of colors;

markings of variable density within a graphical element;

shading of variable density within a graphical element; and

a color of variable intensity within a graphical element.

In various preferred embodiments, the schedule saturation indicator is able to provide a visual indication of a plurality of degrees of saturation, each of the plurality of degrees of saturation indicating a percent of the time interval that is scheduled with events of a specific type. And in certain preferred embodiments the schedule saturation indicator is a rectangle partially filled with a green region and partially filled with a red region.

A third general aspect of the invention is a method for visually indicating a degree of schedule saturation of a time period. The method includes causing an electronic device to display schedule related items on an electronic display. The schedule related items include a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

In preferred embodiments, the schedule related items further include a time-interval-indicator representative of the time interval during which events can be scheduled, the time-interval-indicator being cooperative with the schedule saturation indicator. In some of these preferred embodiments, the time interval represented by the time-interval-indicator is an hour, a day, a week, a month, a quarter, or a year.

In various preferred embodiments, the schedule related items further include a user interface mechanism that enables a user to specify an available fraction of the time interval, the available fraction being a fraction of the time interval that is available for event scheduling, such that the schedule saturation indicator indicates the schedule saturation of the available fraction of the time interval.

In some preferred embodiments, the schedule saturation indicator is able to provide a visual indication of a fraction by displaying at least one of the following:

a numeric indication;

a fractionally filled graphical element;

a graphical element of variable size;

a graphical element of variable orientation;

a graphical element with a continuously variable configuration;

a marker positioned within a visually designated range of locations;

a color included in a graphical element, the color being selected from a range of colors;

markings of variable density within a graphical element;

shading of variable density within a graphical element; and

a color of variable intensity within a graphical element.

In various preferred embodiments, the schedule saturation indicator is able to provide a visual indication of a plurality of degrees of saturation, each of the plurality of degrees of saturation indicating a percent of the time interval that is scheduled with events of a specific type. And in certain preferred embodiments the schedule saturation indicator is a rectangle partially filled with a green region and partially filled with a red region.

In preferred embodiments the electronic display is in communication with the electronic device through a network. And in some of these embodiments the network is the internet

### BRIEF DESCRIPTION OF THE DRAWINGS

FIG. 1A illustrates a preferred embodiment that uses horizontal indicator bars to indicate degrees of schedule saturation for the days of a week;

FIG. 1B illustrates a preferred embodiment similar to the embodiment of FIG. 1A, except that each horizontal indicator bar further indicates the relative amount of the total schedule saturation that is due to each of two different categories of events;

FIG. 2 illustrates a preferred embodiment in which the indicator bars of FIG. 1 are aligned with weeks displayed in a calendar format, so as to indicate degrees of schedule saturation of the weeks;

FIG. 3A illustrates a preferred embodiment schedule saturation indicator that resembles an automobile fuel gage, thereby providing an easily recognized indication of the “fullness” or “emptiness” of a schedule;

FIG. 3B illustrates a preferred embodiment that displays a calendar in which indicator bars similar to those of FIG. 1 and FIG. 2 indicate degrees of schedule saturation of individual days of the month, and the “fuel gage” indicators of FIG. 3A indicate degrees of schedule saturation of entire weeks; and

FIG. 4 illustrates a preferred embodiment similar to the embodiment of FIG. 3B, except that degrees of shading or background colors indicate degrees of schedule saturation of individual days, and indicator bars similar to those of FIG. 2 indicate degrees of schedule saturation for entire weeks.

### DETAILED DESCRIPTION OF PREFERRED EMBODIMENTS

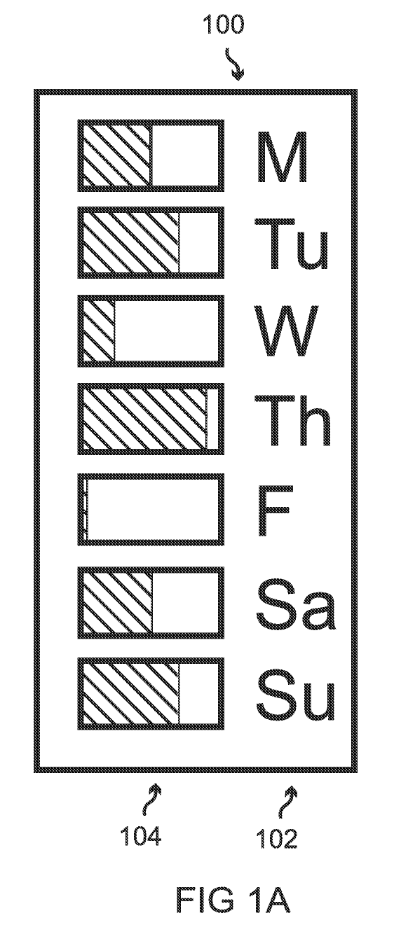

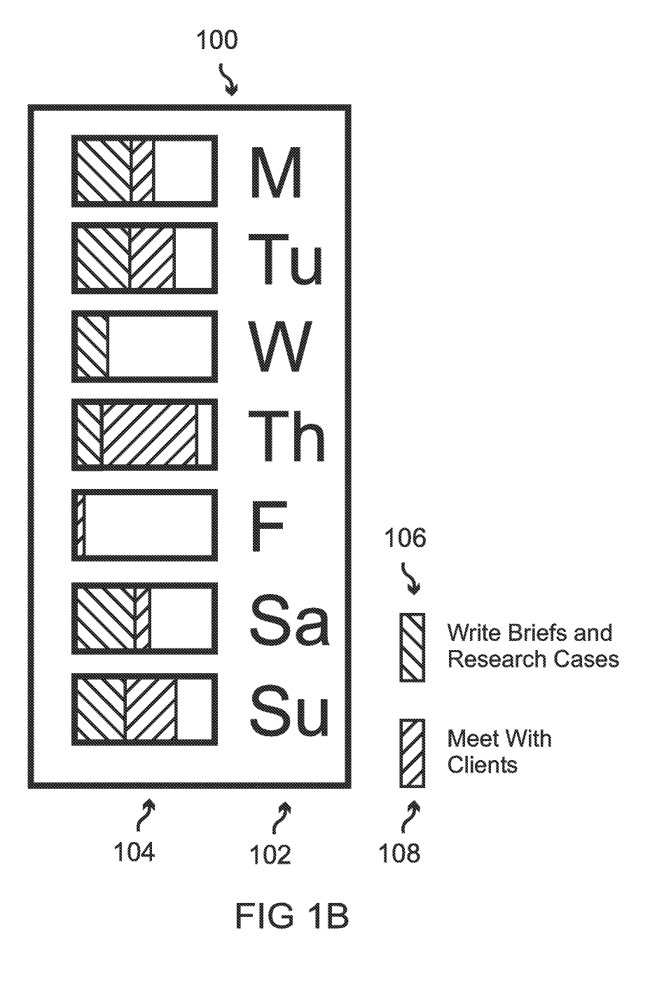

The present invention provides visual indications on an electronic screen of degrees of schedule saturation during indicated time intervals. In the embodiment of FIG. 1A, a simple and highly compact visual presentation 100 is displayed that indicates degrees of saturation of each of the days of a week. A vertical column of time-interval-indicators 102 is presented, wherein each time-interval-indicator is representative of one of the days of the week. A column 104 of schedule saturation indicators appears to the left of the column 102 of time-interval-indicators, such that a schedule saturation indicator 104 is horizontally associated with each time-interval-indicator 102.

In the embodiment of FIG. 1A, the schedule saturation indicators 104 are horizontal, partially filled rectangles, where the degree to which each rectangle is filled represents a fraction from 0 to 1. The fraction indicates the fractional portion of the associated day 102 during which events have been scheduled. In similar embodiments, other forms of fraction indication are used. For example, the rectangles 104 can be partly filled with a red background color and partly filled with a green background color.

It can be seen at a glance from FIG. 1A that Thursday is the most heavily scheduled day, and that Friday has a very light schedule. If, for example, it were desired to schedule an appointment that could take place at any time during the week, it could be seen at a glance from the visual indication 100 of FIG. 1 that Friday has the most open schedule, and is therefore likely to be the best day for the appointment. Depending on the embodiment, a user could then simply click with a mouse on the time-interval-indicator 102 or the schedule saturation indicator 104 for Friday, so as to display an hour-by-hour representation of the schedule for that day, choose an appropriate time, and record the appointment.

FIG. 1B illustrates an embodiment similar to FIG. 1A, except that the filled region of each of the schedule saturation indicators 104 is divided into two parts, thereby indicating the relative amount of each day that has been scheduled for each of two separate categories of events. FIG. 1B is an example of an embodiments in which at least some events can be “scheduled” during a time period without being assigned specific times. In the specific example of FIG. 1B, the schedule applies to a lawyer who is able to schedule client visits at specific times throughout the work day, but must nevertheless reserve a certain number of hours for writing briefs and researching cases. The writing and researching time does not have to be scheduled for specific hours, so long as sufficient time remains during which client appointments have not been scheduled. In this embodiment, the user can right click on each day so as to activate a pop-up window that enables entry of the amount of time that must be set aside each day for writing and researching. In various embodiments, schedule saturation indications are divided into three or more sub-components.

In some embodiments, a user can simply indicate a portion of a total time period that is available for scheduling events, such that the schedule saturation indicator will indicate a single fraction representing how much of that available portion has been scheduled.

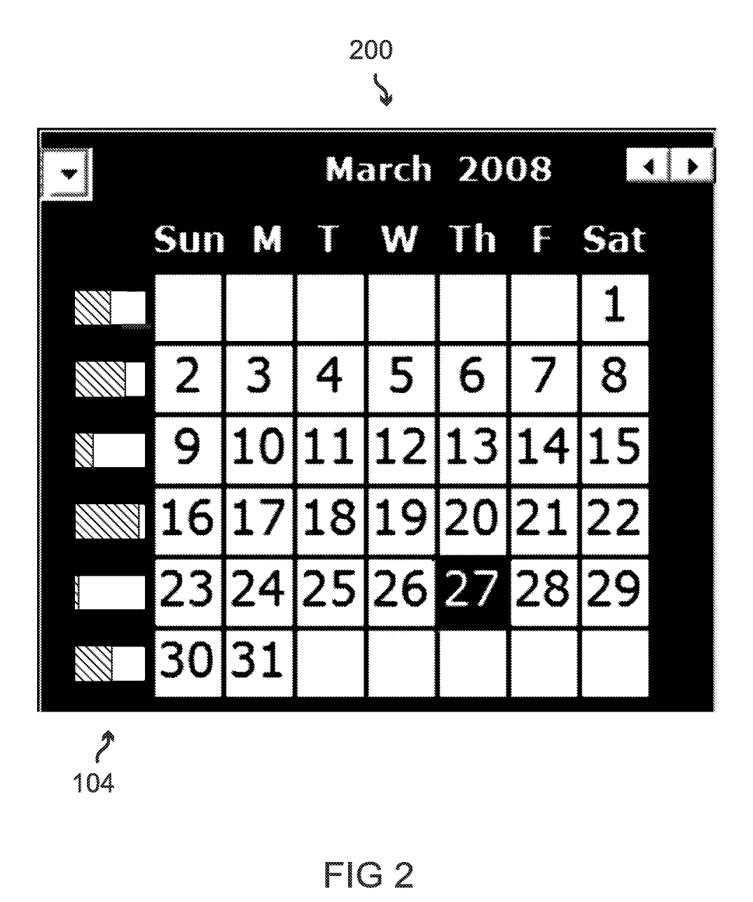

FIG. 2 illustrates an embodiment in which a compact calendar representation of an entire month is displayed 200, with each row of days serving as a time-interval-indicator for a specific week. A schedule saturation indicator 104 is presented to the left of each week, and is therefore horizontally associated with that week. The schedule saturation indicators 104 in this embodiment are similar to the schedule saturation indicators 104 of FIG. 1. When scheduling an appointment, it can be seen at a glance from the schedule saturation indicators 104 of FIG. 2 that the weeks of March 9 and March 23 are the least heavily scheduled. Depending on the embodiment, an expanded view of a single week or of a single day can be obtained for example by clicking with a mouse on a schedule saturation indicator 104 or on a single day in the calendar 200.

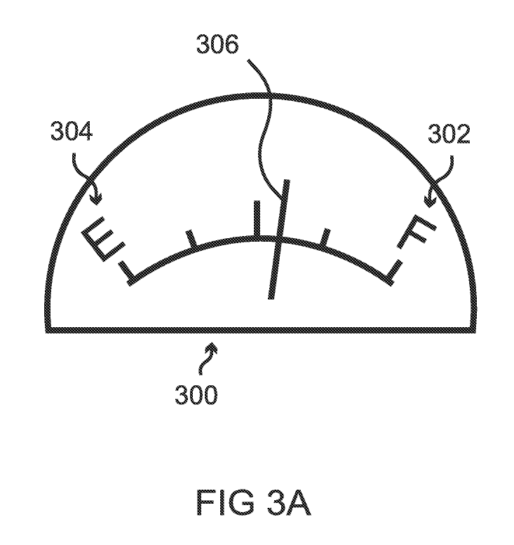

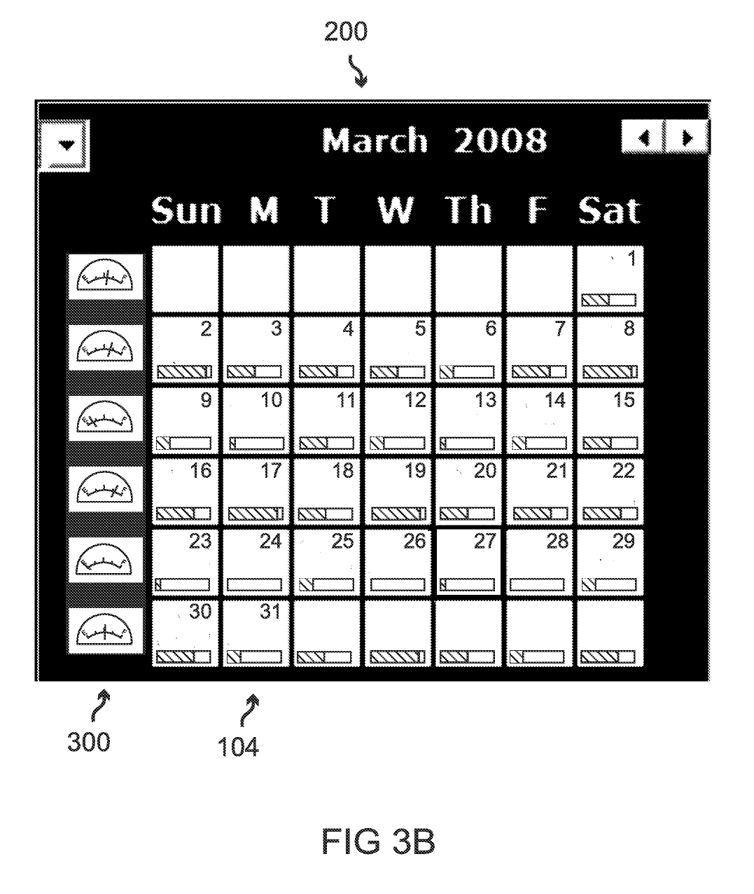

FIG. 3A illustrates a preferred embodiment schedule saturation indicator 300 that visually resembles a typical automotive fuel gage. A “full” marker is presented on the right side as a capital letter “F” 302, and an “empty” marker is presented on the left side as a capital letter “E” 304, thereby indicating “full” and “empty” schedules. A pointer 306 similar to what would be found in a fuel gage indicates the relative “fullness” or “emptiness” of the schedule for the corresponding time interval.

FIG. 3B illustrates use of the schedule saturation indicators 300 of FIG. 3A in a preferred embodiment that displays a calendar representation 200 of an entire month. The calendar representation 200 in this embodiment is larger than the calendar representation 200 of FIG. 2, thereby providing space to indicate the schedule saturation of each day as well as the schedule saturation of each week. A partially filled rectangle 104 is used as the schedule saturation indicator for each day of the month, and a “fuel gage” indicator 300 is used as the schedule saturation indicator for each week of the month. In the example presented in FIG. 3B, it can be immediately seen that the week of March 23 is the most lightly scheduled, and that the schedules for March 24, 26, and 28 are completely open.

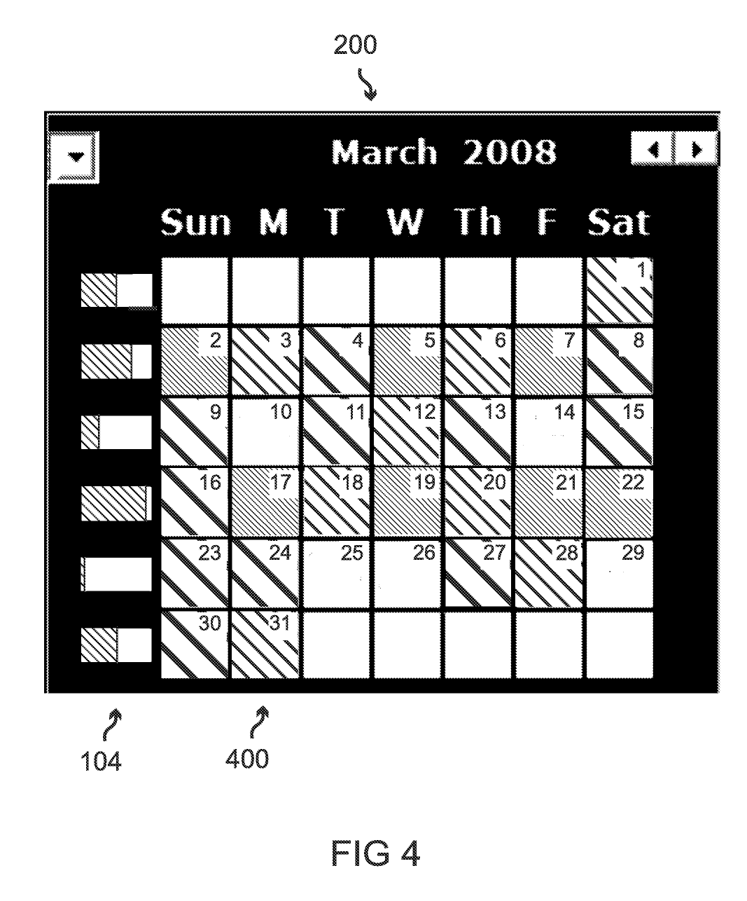

FIG. 4 illustrates an embodiment similar to the embodiment of FIG. 3B, except that partially filled rectangles 104 are used as schedule saturation indicators for each week of the month, and a degree of background shading 400 or a background color chosen from a range of colors (for example from the colors of the rainbow) is used to indicate the degree of schedule saturation for each day. Because degrees of background shading or background colors chosen from a range of colors are used to indicate the schedule saturation of each day, the calendar 200 of FIG. 4 can be rendered on an electronic screen in a smaller size and/or with lower resolution than the calendar 200 of FIG. 3B.

Depending on the embodiment, the visual indications of the present invention can be displayed on any electronic display, including the screen of a computer, such as a personal computer, or on the display of a hand-held device such as a personal digital assistant “PDA,” cell phone, or similar device. The electronic device that generates the visual indication can be a local device, or it can be a server computer or other electronic device that is in communication by wired or wireless means with the electronic display, for example over the internet over the telephone network, or over some other network.

Other modifications and implementations will occur to those skilled in the art without departing from the spirit and the scope of the invention as claimed. Accordingly, the above description is not intended to limit the invention except as indicated in the following claims.

What is claimed is:

1. An article of manufacture for visually indicating a degree of schedule saturation of a time period, the article of manufacture comprising:
media containing software that is able to direct the actions of an electronic device so as to present schedule related items on an electronic display, the schedule-related items including:
a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

2. The article of manufacture of claim 1, wherein the schedule related items further include a time-interval-indicator representative of the time interval during which events can be scheduled, the time-interval-indicator being cooperative with the schedule saturation indicator.

3. The article of manufacture of claim 2, wherein the time interval represented by the at least one time-interval-indicator is one of an hour, a day, a week, a month, a quarter, and a year.

4. The article of manufacture of claim 1, wherein the schedule-related items include a user interface mechanism that enables a user to specify an available fraction of the time interval, the available fraction being a fraction of the time interval that is available for event scheduling, such that the schedule saturation indicator indicates the schedule saturation of the available fraction of the time interval.

5. The article of manufacture of claim 1, wherein the schedule saturation indicator is able to provide a visual indication of a fraction by displaying at least one of:
a numeric indication;
a fractionally filled graphical element;
a graphical element of variable size;
a graphical element of variable orientation;
a graphical element with a continuously variable configuration;
a marker positioned within a visually designated range of locations;
a color included in a graphical element, the color being selected from a range of colors;
markings of variable density within a graphical element;
shading of variable density within a graphical element; and
a color of variable intensity within a graphical element.

6. The article of manufacture of claim 1, wherein the schedule saturation indicator is able to provide a visual indication of a plurality of degrees of saturation, each of the plurality of degrees of saturation indicating a percent of the time interval that is scheduled with events of a specific type.

7. The article of manufacture of claim 1, wherein the schedule saturation indicator is a rectangle partially filled with a green region and partially filled with a red region.

8. A device for visually indicating a degree of schedule saturation of a time period, the device comprising:
an electronic device that is able to display schedule related items on an electronic display, the schedule related items including:
a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

9. The article of manufacture of claim 8, wherein the schedule related items further include a time-interval-indicator representative of the time interval during which events can be scheduled, the time-interval-indicator being cooperative with the schedule saturation indicator.

10. The device of claim 9, wherein the time interval represented by the at least one time-interval-indicator is one of an hour, a day, a week, a month, a quarter, and a year.

11. The device of claim 8, wherein the schedule-related items include a user interface mechanism that enables a user to specify an available fraction of the time interval, the available fraction being a fraction of the time interval that is available for event scheduling, such that the schedule saturation indicator indicates the schedule saturation of the available fraction of the time interval.

12. The device of claim 8, wherein the schedule saturation indicator is able to provide a visual indication of a fraction by displaying at least one of:
a numeric indication;
a fractionally filled graphical element;
a graphical element of variable size;
a graphical element of variable orientation;
a graphical element with a continuously variable configuration;
a marker positioned within a visually designated range of locations;
a color included in a graphical element, the color being selected from a range of colors;
markings of variable density within a graphical element;
shading of variable density within a graphical element; and
a color of variable intensity within a graphical element.

13. The device of claim 8, wherein the schedule saturation indicator is able to provide a visual indication of a plurality of degrees of saturation, each of the plurality of degrees of saturation indicating what percent of the time interval is scheduled with events of a specific type.

14. The device of claim 8, wherein the schedule saturation indicator is a rectangle partially filled with a green region and partially filled with a red region.

15. A method for visually indicating a degree of schedule saturation of a time period, the method comprising:
causing an electronic device to display schedule related items on an electronic display, the items including:
a schedule saturation indicator associated with a time interval during which events can be scheduled, the schedule saturation indicator being able to provide a visual indication of a degree of schedule saturation of the time interval, wherein the degree of schedule saturation can range from no saturation to complete saturation, and any degree of saturation there between.

16. The article of manufacture of claim 15, wherein the schedule related items further include a time-interval-indicator representative of the time interval during which events can be scheduled, the time-interval-indicator being cooperative with the schedule saturation indicator.

17. The method of claim 16, wherein the time interval represented by the at least one time-interval-indicator is one of an hour, a day, a week, a month, a quarter, and a year.

18. The method of claim 15, wherein the schedule-related items include a user interface mechanism that enables a user to specify an available fraction of the time interval, the available fraction being a fraction of the time interval that is available for event scheduling, such that the schedule saturation indicator indicates the schedule saturation of the available fraction of the time interval.

19. The method of claim 15, wherein the schedule saturation indicator is able to provide a visual indication of a fraction by displaying at least one of:
a numeric indication;
a fractionally filled graphical element;
a graphical element of variable size;
a graphical element of variable orientation;
a graphical element with a continuously variable configuration;
a marker positioned within a visually designated range of locations;
a color included in a graphical element, the color being selected from a range of colors;
markings of variable density within a graphical element;
shading of variable density within a graphical element; and
a color of variable intensity within a graphical element.

20. The method of claim 15, wherein the schedule saturation indicator is able to provide a visual indication of a plurality of degrees of saturation, each of the plurality of degrees of saturation indicating what percent of the time interval is scheduled with events of a specific type.

21. The method of claim 15, wherein the schedule saturation indicator is a rectangle partially filled with a green region and partially filled with a red region.

22. The method of claim 15, wherein the electronic display is in communication with the electronic device through a network.

23. The method of claim 22, wherein the network is the internet.
